(19) United States
(12) Patent Application Publication
(10) Pub. No.: US 2010/0061824 A1
(43) Pub. Date: Mar. 11, 2010

(54) SCREW

(75) Inventor: CHING-GUEI LIN, KAOHSIUNG COUNTY 821 (TW)

Correspondence Address: ROSENBERG, KLEIN & LEE, 3458 ELLICOTT CENTER DRIVE-SUITE 101, ELLICOTT CITY, MD, 21043, US

(73) Assignee: CHANG CHIN INDUSTRY CORP., KAOHSIUNG COUNTY 821 (TW)

(21) Appl. No.: 12/207,728

(22) Filed: Sep. 10, 2008

(51) Int. Cl. F16B 25/10

(52) U.S. Cl. 411/387.5

(57) ABSTRACT

The present invention pertains to a screw essentially comprising a plurality of bulges disposed on threads of the screw and unengaged with a shank; whereby a consecutive extrusion path is formed between the bulges and the shank. Herein, while the bulges facilitate the screw threads to efficiently chop fibers of the object into debris and render the screw to easy drill into the object, the extrusion path smoothly guides and extrudes the debris therealong. Thus, the present invention conduces to decrease the drilling torque resulting in a speedily screwing; moreover, the bulges also allow the unsevered fibers hugging therearound to enhance the screw firmness inside the object.

### BACKGROUND OF THE INVENTION

1. Field of the Invention

The present invention relates to a screw, in particular to a screw that assists in decreasing the drilling torque to increase the screwing speed as well as promoting the firm screwing.

2. Description of the Related Art

A conventional screw 1 shown in FIG. 1 generally comprises a head 11, a shank 12 outwardly extended from the head 11, a plurality of threads 13 spiraling round the shank 12, a drilling portion 14 disposed on the shank 12 and located opposite to the head 11, and a plurality of bulges 15 disposed at regular intervals on the threads 13. Wherein, each of the threads 13 has two flanks 131 extending from the outer periphery of the shank 12 as well as a thread peak 132 defined where the flanks 131 congregate. The bulges 15 are further outwardly extended from the shank 12 toward the thread peak 132 and correspondingly protruded on the flanks 131 of the threads 13.

Further referring to FIGS. 1 and 2, while driving the screw 1 into an object 2, the bulges 15 forms an enlarged bore for allowing the threads 13 to follow the bore track and enter into the object 2 and helps the object fibers to be cut into debris. However, in view of the confinement of the bulges 15 protruded from the shank 12 to the peak 132, a room 21 formed between any two of the threads 13 for receiving debris is relatively restricted. Although the debris just fills with the limited room 21 and surrounds the shank 12, it still cannot attain a favorable screwing firmness of the screw 1 into the object 2 as the room 21 cannot accommodate enough amount of the debris. Furthermore, the forced entwining of the unsevered fibers round the shank 12 would also incur a large drilling torque in time of incessantly drilling the screw 1 into the object 2 since the threads 13 of the screw 1 would not fully chop all the fibers.

Besides, as arrowed in FIG. 3, when the cutting debris travels along the threads 13, it is difficult to smoothly extrude the debris as the configuration of the bulges 15 is an obstacle to the debris, namely the debris would be obstructed and adversely piled up between the bulges 15, which however results in the debris unable to travel therethrough and guide out of the object 2 until the later debris attains at a certain amount to forcedly push the afore debris moving forward. Therefore, the jam and the accumulation of the debris within the room 21 generates an reverse resistance and results of the increment of the drilling torque as well as the decrease of the screwing speed and drilling efficiency, even to crack the object 2 while screwing.

### SUMMARY OF THE INVENTION

The object of the present invention is to provide a screw to achieve a speedy screwing and a decreased drilling torque so as to increase the screwing efficiency.

The screw in accordance with the present invention mainly comprises a head, a shank outwardly extended from the head, a plurality of threads spiraling round the shank, and a drilling portion disposed on the shank, opposite to the head. Wherein, each thread has two flanks and either of which has a plurality of bulges placed apart thereon; said bulges are not engaged with the shank, so that a consecutive extrusion path is defined between the bulges and the shank. Therefore, in the preliminary drilling, the bulges assist the threads in chopping fibers of an object and render the screw to easily enter into the object; further, the redundant debris can untrammelledly and smoothly pass along the extrusion path to be ejected out of the object even it is obstructed by the bulges. Thus, the screw is capable of reducing its drilling torque to raise the screwing speed. The remained non-chopped fibers along with the remained debris would also firmly gather and entwine around the bulges to promote the screwing firmness after screwing.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a plan view showing a conventional screw;

FIG. 2 is a schematic view showing the conventional screw screwed among an object;

FIG. 3 is a schematic view showing the motion of the debris of the conventional screw while screwing;

FIG. 4 is a perspective view showing a first preferred embodiment of the present invention;

FIG. 5 is a cross-sectional view showing the A-A section in FIG. 4;

FIG. 6 is schematic view showing a second preferred embodiment of the present invention;

FIG. 7 is a schematic view showing the first preferred embodiment screwed among an object;

FIG. 8 is a schematic view showing the motion of the debris of the present invention while screwing;

FIG. 9 is a perspective view showing a third preferred embodiment of the present invention;

FIG. 9A is a partial enlarged view of FIG. 9;

FIG. 9B is a partial enlarged view showing a fourth preferred embodiment of the present invention;

FIG. 10 is a schematic view showing of FIG. 9 screwed among an object;

FIG. 11 is a schematic view showing a fifth preferred embodiment of the present invention; and

FIG. 12 is a bottom view showing of FIG. 11.

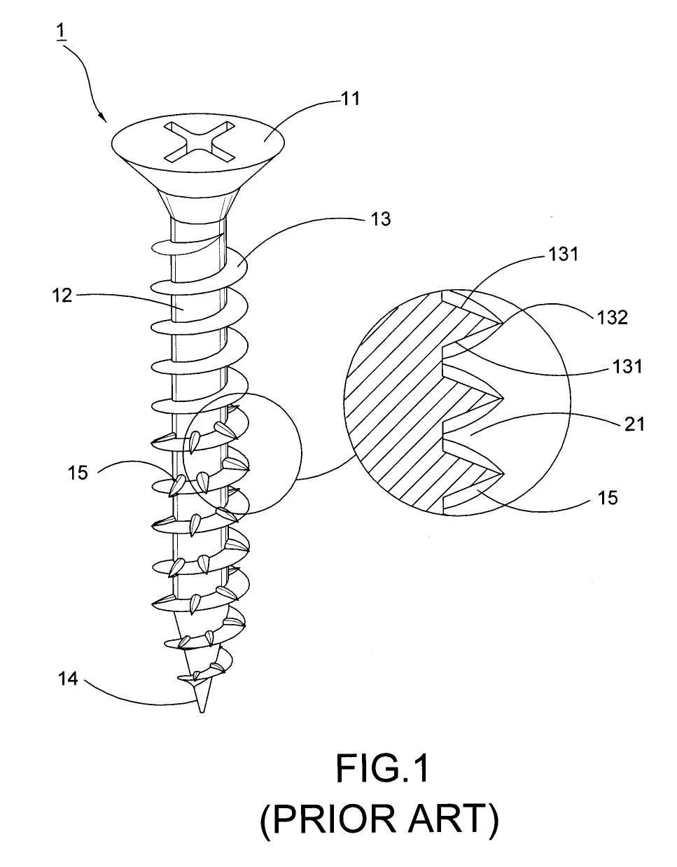

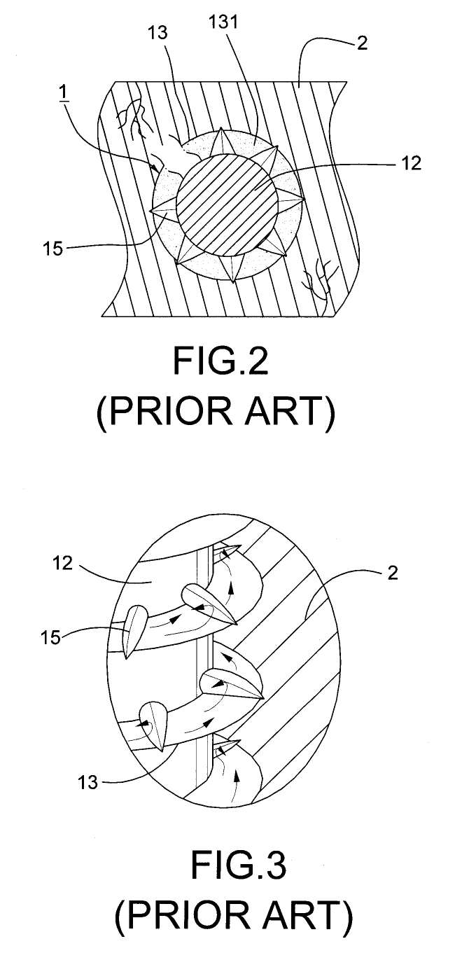

### DETAILED DESCRIPTION OF THE PREFERRED EMBODIMENTS

Before describing in greater detail, it should note that the like elements are denoted by the similar reference numerals throughout the disclosure.

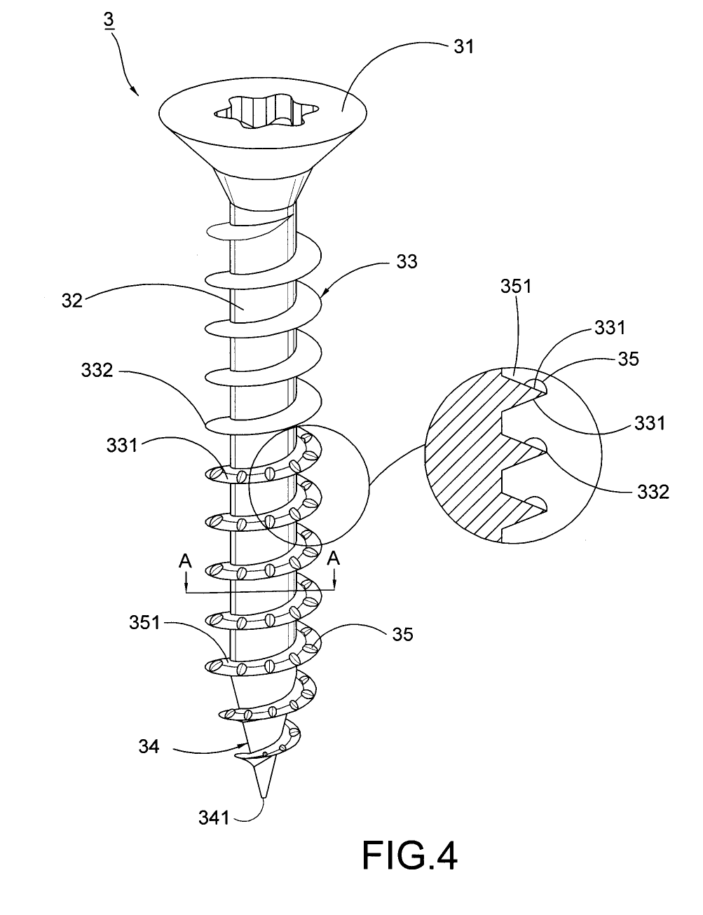

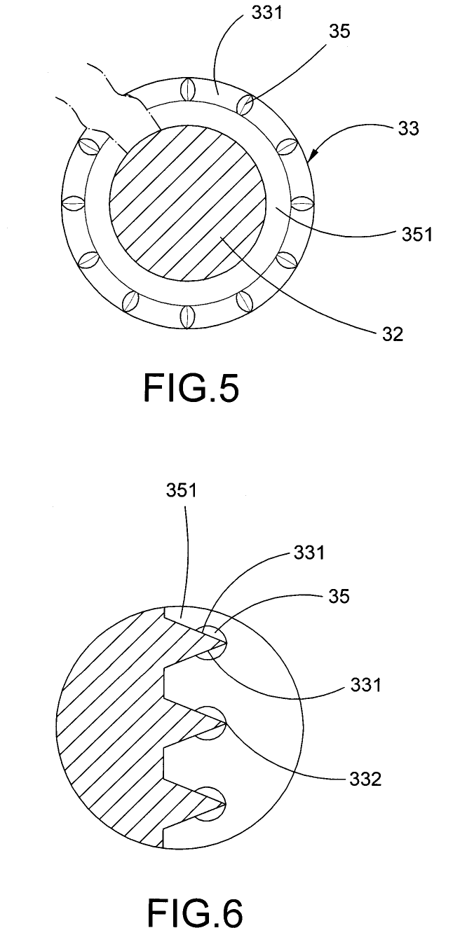

Referring to FIGS. 4 and 5, a screw 3 of a first preferred embodiment comprises a head 31, a shank 32 outwardly extended from the head 31 and forming a drilling portion 34 with a pointed tip 341 to be disposed opposite to the head 31, and a plurality of threads 33 spiraling round the shank 32 and incessantly distributing over the drilling portion 34. Wherein, each of the threads 33 has two flanks 331 respectively extending from the outer periphery of the shank 32, and a thread peak 332 is defined at the convergence of the two flanks 331. Further, a plurality of bulges 35 are disposed on either flank 331; each bulge 35 provides with one end thereof to disconnect from the shank 32 and with other end thereof to contact with the thread peak 332 so as to form a consecutive extrusion path 351 between the shank 32 and the bulges 35.

Particularly, the bulges 35 can be merely disposed on one flank 331, for instance of being on the upper flank 331 of the thread 33 in FIG. 4, or can be correspondingly disposed on both flanks 331 as shown in FIG. 6. It should be noted that the following configuration will be particularly described basing on the first preferred embodiment in consideration of the bulges 35 being disposed on either one flank 331 which achieves the same manipulations and competences as the elements on both flanks 331.

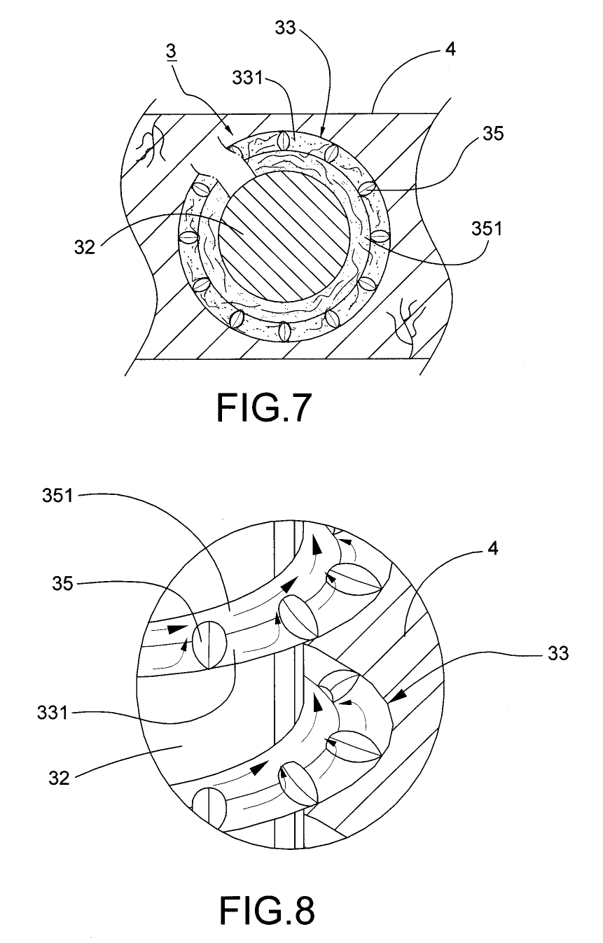

Referring to FIGS. 4 and 7, in operation, a force is initially imparted upon the head 31 to rotate the drilling portion 34 as well as the threads 33 drilling into an object 4 with wooden fiber. Further, the threads 33 accompanying the bulges 35 expand a drilling bore on the object 4 and simultaneously sever the fibers into debris, so that the attendant threads 33 are capable of rapidly entering into the object 4 by following the expanded bore track to decrease the drilling torque. When the drilling and cutting of the threads 33 and the bulges 35 keep working, the redundant debris is capable of being smoothly extruded out of the object 2 along the extrusion path 351. As plainly arrowed in FIG. 8, by means of the existing of the extrusion path 351, the debris would in turn to be pushed toward the extrusion path 351 and be progressively guided out of the object 4 when it is impeded by the bulges 35, and which accordingly facilitates decreasing the drilling torque and achieving a speedy screwing as well as avoids the broken of the object 4 by the guidance of the extrusion path 351 that prevents the occurrence of excessively accumulating debris and of the forced jam of the debris within the threads 33.

Still referring to FIG. 7, after screwing the screw 3 into the object 4, the remain debris (shown by the dots) which is not extruded out of the object 4 distributively and consecutively fills with the threads 33, namely among the extrusion path 351 and the bulges 35, so that the screw 3 can achieve a preferable firmness within the object 4 as the installation of the bulges 35 would not affect the amount of the remained debris accommodating between the threads 33. Moreover, the unsevered fibers (shown by irregular solid lines) with the elasticity would also tightly wrap around the bulges 35 and further congregate with the debris within the threads 33. Therefore, the screw 3 can steadily prevent itself from loosening while being subjected to an external force.

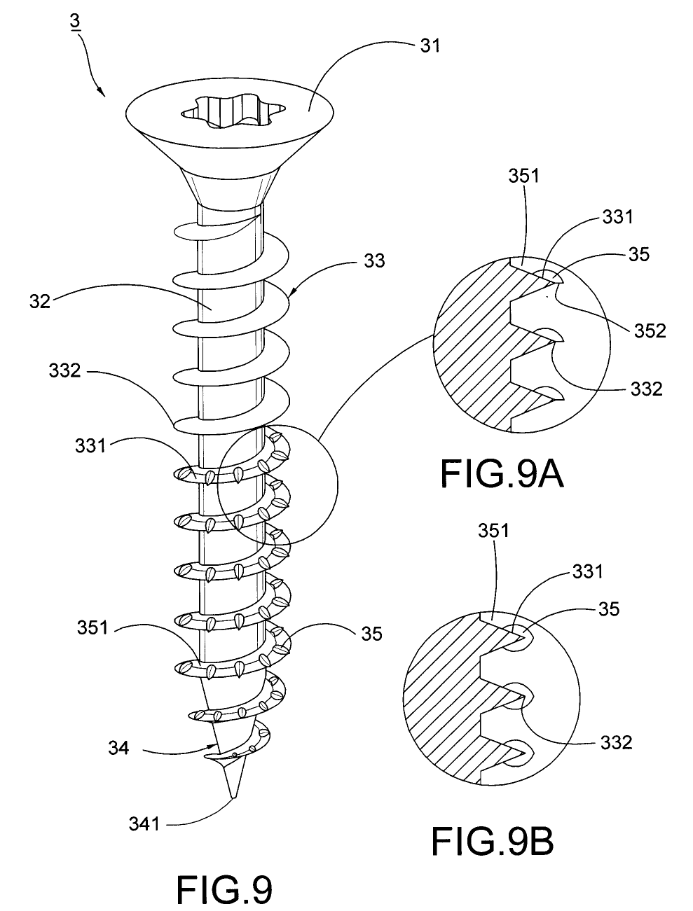

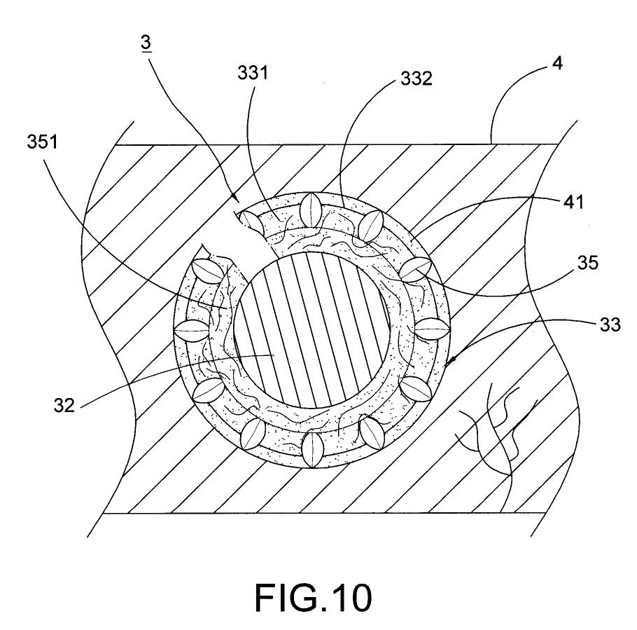

Referring to FIG. 9, a screw 3 of a third preferred embodiment still comprises a head 31, a shank 32, threads 33, and a drilling portion 34. Different from the first preferred embodiment that each bulge 35 with its other end to just contact with the thread peak 332, the bulge 35 of this embodiment disposed on either flank 331 particularly projects out of the thread peaks 332 as well as concomitantly has an extending surface 352 connecting with the thread peaks 332 (see FIG. 9A). Accordingly, the projected bulges 35 substantially create an enlarged bore 41 while drilling the screw 3 into the object 4 and permit the succeeding threads 33 to follow the track of the bore 41 for an easy and rapid entry, so that the redundant debris can be extruded out of the object 4 along the extrusion path 351 and the space between the bore 41 and the threads 33 as more clearly shown in FIG. 10. Hence the drilling torque is relatively decreased. Concurrently, the extrusion path 351 also applies to congregate the remained debris therein, and the unsevered wooden fibers would also tightly wrap around the bulges 35 basing on their elasticity, which hence prevent the problem of loosening from the object 4 and achieves a tighter and firmer screwing efficiency.

Besides, further referring to FIG. 9B showing a fourth preferred embodiment of the present invention, the bulges 35 are disposed on both the flanks 331 integrally project out of the thread peaks 332 so as to perform in a hugging statement. Still referring to FIG. 10, the integral bulges 35 on the threads 33 can also generate an enlarged bore 41 whereby the succeeding threads 33 are capable of efficiently traveling therein to decrease the drilling torque. In this manner, the debris can further gather within the extrusion path 351; in addition, the resilient wooden fiber will tightly embrace the integral bulges 35, which results in filling with the extrusion path 351 and the thread peaks 332 to enhance the screwing firmness.

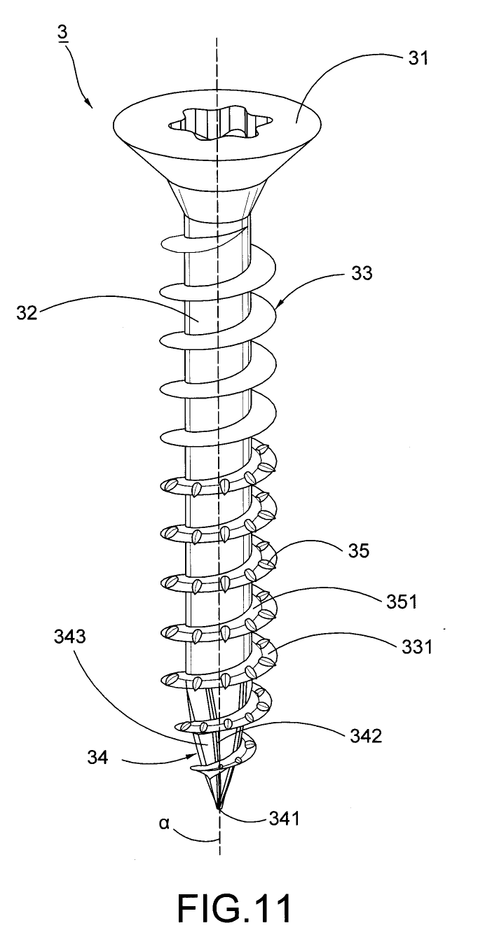

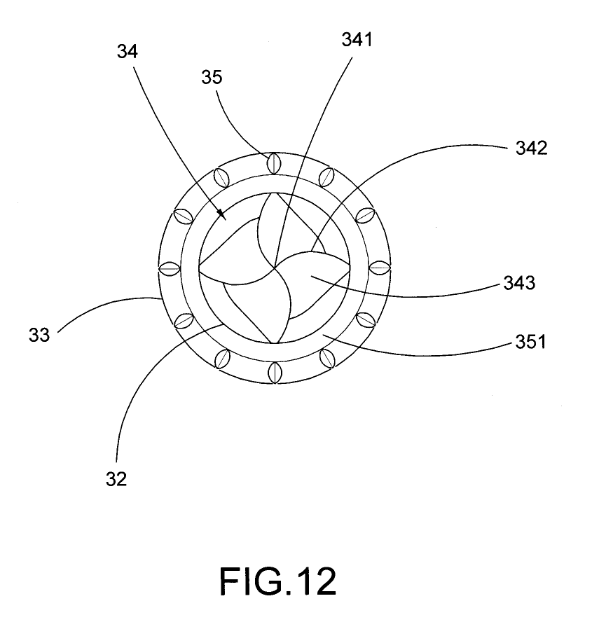

Besides the aforementioned embodiments, the screw 3 can also have another embodiment for more strengthening the screwing capability. FIGS. 11 and 12 showing a fifth preferred embodiment comprises a head 31, a shank 32 extended from the head 31, threads 33 spiraling round the shank 32, and bulges 35 instanced to be disposed on both upper and lower flanks 331 as the same as the second embodiment to define an extrusion path 351. Especially, a drilling portion 34, over which the threads 33 continuously distributing, is outwardly extended from the shank 32 and located opposite to the head 31. The drilling portion 34 has a pointed tip 341 at its distal end. At least three drilling ridges 342 radiate from a pointed tip 341 and incline to a central axis “α” of the shank 32, and four drilling ridges 342 are preferably adopted in this embodiment. Between any two drilling ridges 342 further forms a drilling surface 343. More explicitly, one end of each drilling ridge 342 connects to the pointed tip 341, the other end of which connects to the joint of the shank 32 and the drilling portion 34.

Still referring to FIGS. 11 and 12, while the threads 33 on the drilling portion 34 keep drilling into an object (not shown), the drilling ridges 342 and the drilling surfaces 343 progressively sever and shatter the wooden fibers into debris to overcome the occurrence of the entwining of the fibers around the shank 32 and further to decrease the drilling torque. The screwing speed hence can be promoted. In addition, a bore (not shown) expansively created via the drilling ridges 342 not only makes an easy entry into the object but also renders the debris to be further promptly extruded through the extrusion path 351 and the space between the enlarged bore and the thread 33. Thus, the screw 3 requires lower drilling torque and substantially save the labor imparted thereon. Such drilling portion 34 readily chops the fibers and cooperates with the bulges 35 and the extrusion path 351 to eject the redundant debris so as to avoid the destruction of the object during the introduction of drilling and to more promote the afore performance of the screw 3 and the using convenience.

To sum up, the present invention takes advantage of a plurality of bulges on threads disconnected from the screw shank and a formation of a consecutive extrusion path to efficiently chop wooden fibers into debris, readily drive the screw into the object, and allow a free motion of the debris along the extrusion path, thereby the decreasing drilling torque for the purpose of increment of the screwing speed as well as avoiding cracking object due to the jam of the debris. The unsevered fibers would also tightly hug round the bulges to promote the screwing firmness. Besides, a drilling portion of the present invention can alternatively have its drilling portion to provide with sloping drilling ridges along with a drilling surface formed therebetween so as to enhance the chopping capability of the screw, which hence more prevents the object from destruction and decreases the drilling torque as well as increases the screwing speed.

While we have shown and described the embodiment in accordance with the present invention, it should be clear to those skilled in the art that further embodiments may be made without departing from the scope of the present invention.

I claim:

1. A screw comprising:
a head;
a shank outwardly extended from said head and forming a drilling portion to be disposed opposite to said head; said drilling portion further providing with a pointed tip at a free end thereof;
a plurality of threads spiraling round said shank and continuously distributing toward said drilling portion; each of said threads having two flanks respectively extending from the outer periphery of said shank as well as a thread peak defined at which said two flanks converge; and
a plurality of bulges spaced apart on either of said two flanks and disconnected from said shank so as to define a consecutive extrusion path between said bulges and said shank.

2. The screw as claimed in claim 1, wherein said bulges are arranged on said both flanks.

3. The screw as claimed in claim 1, wherein each of said bulge projects out of said thread peak and concomitantly has an extending surface connecting with said thread peak.

4. The screw as claimed in claim 2, wherein said bulges defined on said both flanks integrally project out of said thread peak so as to perform in a hugging statement.

5. The screw as claimed in claim 1, wherein said drilling portion has at least three drilling ridges radially disposed from said pointed tip and inclined with respect to a central axis of said shank; a drilling surface is further formed among any two of said drilling ridges.

6. The screw as claimed in claim 5, wherein said drilling portion preferably has four drilling ridges.

7. The screw as claimed in claim 2, wherein said drilling portion has at least three drilling ridges radially disposed from said pointed tip and inclined with respect to a central axis of said shank; a drilling surface is further formed among any two of said drilling ridges.

8. The screw as claimed in claim 7, wherein said drilling portion preferably has four drilling ridges.
